(19) United States
(12) Patent Application Publication
(10) Pub. No.: US 2012/0205309 A1
(43) Pub. Date: Aug. 16, 2012

(54) METHOD AND DEVICE FOR SEPARATING SOLVENT FROM LIQUID INCLUDING SOLVENT AND SOLUTE

(75) Inventors: Kenji Sano, Tokyo (JP); Hideyuki Tsuji, Yokohama-shi (JP)

(73) Assignee: KABUSHIKI KAISHA TOSHIBA, Tokyo (JP)

(21) Appl. No.: 13/367,730

(22) Filed: Feb. 7, 2012

(30) Foreign Application Priority Data
Feb. 10, 2011 (JP) 2011-027745

(51) Int. Cl. B01D 61/02; B01D 63/00; C02F 1/44; C02F 103/08

(52) U.S. Cl. 210/638; 210/652; 210/321.72; 210/295

(57) ABSTRACT

According to one embodiment, a method for separating a solvent from an object solution includes the solvent and a solute is provided. The method includes preparing a forward osmosis membrane having a first surface and a second surface, and contacting the first surface of the membrane with the object solution and contacting the second surface with a liquid for collection. A substance having solidity is configured to exert a force for transferring the solvent in the object solution to the membrane, and disposed on the second surface of the membrane and/or dispersed in the liquid for collection to transfer the solvent in the object solution from the first surface to the liquid for collection.

### CROSS-REFERENCE TO RELATED APPLICATIONS

This application is based upon and claims the benefit of priority from prior Japanese Patent Application No. 2011-027745, filed Feb. 10, 2011, the entire contents of which are incorporated herein by reference.

### FIELD

Embodiments described herein relate generally to a unit configured to separate a solvent from a liquid comprising the solvent and a solute.

### BACKGROUND

Methods that are currently used for separating a solvent from a liquid comprising the solvent and a solute are mainly a reverse osmosis membrane process and a forward osmosis membrane process. For example, in the case when fresh water is to be obtained from seawater, the above-mentioned methods are conducted as follows.

In a reverse osmosis pressure desalination process (also referred to as “RO process”), seawater and water are separated by a reverse osmosis membrane (also referred to as “RO membrane”), and a high pressure, for example, a pressure of 55 atm is applied to the reverse osmosis membrane from the seawater side. By doing so, water included in seawater passes through the reverse osmosis membrane and transfers to the side of water. By such a process, fresh water can be obtained from seawater.

On the other hand, in a forward osmosis pressure membrane desalination process (also referred to as “FO process”), seawater and an aqueous solution of ammonium carbonate having a higher molar number than that of seawater are separated by a forward osmosis membrane (also referred to as “FO membrane”). The ammonium carbonate is supplied by supplying gaseous carbon dioxide and gaseous ammonia. By this constitution, water included in seawater transfers to the side of the aqueous solution of ammonium carbonate. Thereafter the aqueous solution of ammonium carbonate comprising the transferred water is heated to 60° C. to decompose ammonium carbonate by heating. As a result, fresh water can be obtained from seawater.

### BRIEF DESCRIPTION OF THE DRAWINGS

FIG. 1 is a block diagram showing the constitution of the device of an exemplary embodiment;

FIG. 2 is a schematic view showing the constitution of the device of another exemplary embodiment;

FIG. 3 is a drawing showing the constitution of an example of the substance having solidity used in the exemplary embodiment;

FIG. 4 is a schematic view showing the constitution of the device used in Test 1;

FIG. 5 is a schematic view showing the constitution of the device used in Test 2; and

FIGS. 6A, 6B, 6C and 6D are schematic views showing the constitutional examples of the device of the exemplary embodiment.

### DETAILED DESCRIPTION

The method for separating a solvent from an object solution comprising the solvent and a solute of the exemplary embodiment comprises preparing a forward osmosis membrane having a first surface and a second surface, and contacting the first surface of the forward osmosis membrane with the object solution and contacting the second surface with a liquid for collection. In this method, a substance having solidity that is configured to exert a force for transferring the solvent in the object solution to the forward osmosis membrane is disposed on the surface of the second surface of the forward osmosis membrane and/or dispersed in the liquid for collection to transfer the solvent in the object solution from the first surface to the liquid for collection at the side of the second surface through the forward osmosis membrane, thereby the solvent is separated from the object solution.

The “solidity” in the substance having solidity refers to being substantially insoluble in the solvent to be separated and/or solution for collection. “Substantially insoluble” refers to that the substance having solidity being maintained in a state that it can be separated or readily separated from the separated solvent, for example, the substance having solidity is maintained as a solid without flowing out, in a state that the substance having solidity is present together with the solvent to be separated and/or the solution for collection. Furthermore, even if the substance having solidity dissolves in the solvent or solution for collection in question, a trace amount of such a substance may be used for the substance having solidity. Here, an infinitesimal quantity may be determined by determining whether or not the dissolved substance having solidity is in an amount by which any inconvenience, for example, any inconvenience or obstruction that blocks the purpose of use after collection, is not caused when the dissolved substance having solidity is included in the solvent to be separated and/or solution for collection. Any material may be used as the substance having solidity in said method as long as it becomes a combination that does not cause such obstruction of or interference to the solvent and/or solution for the collection in question.

The problem to be solved by the embodiments is to provide a method and a device for separating a solvent from a liquid comprising the solvent and a solute with lesser energy.

According to one aspect, a method for separating a solvent from an object solution comprising the solvent and a solute is provided,

the method comprising:

preparing a forward osmosis membrane having a first surface and a second surface, and

contacting the first surface of the forward osmosis membrane with the object solution and contacting the second surface with a liquid for collection,

wherein a substance having solidity that is configured to exert a force for transferring the solvent in the object solution to the forward osmosis membrane is disposed on the second surface of the forward osmosis membrane and/or dispersed in the liquid for collection to transfer the solvent in the object solution from the first surface to the liquid for collection at the side of the second surface through the forward osmosis membrane, thereby the solvent is separated from the object solution.

1. Separating Method for Solvent

According to one embodiment, a method for separating a solvent from an object solution comprising the solvent and a solute(also referred to as “separating method for solvent”) is provided. The method substantially includes preparing a forward osmosis membrane having a first surface and a second surface, and contacting the first surface of the membrane with the object solution and contacting the second surface with a liquid for collection. In these steps, a substance having solidity is configured to exert a force for transferring the solvent in the object solution to the forward osmosis membrane, and the substance having solidity is disposed on the second surface of the forward osmosis membrane and/or dispersed in the liquid for collection to transfer the solvent in the object solution from the first surface to the liquid for collection at the side of the second surface through the forward osmosis membrane, thereby the solvent is separated from the object solution.

In this method, the separation of the solvent from the object solution is conducted by utilizing the concentration difference between the solutes that are included in the solution and in the liquid for collection that are present on the areas with which the both surfaces of the forward osmosis membrane, i.e., the first surface and the second surface contact, respectively. The concentration difference of the solutes can be obtained by the difference of the concentrations of the same kind of substances that are present on the both surfaces of the forward osmosis membrane. The concentration may be represented by the amount of the mass with respect to the solvent, and for example, it may be represented by mol concentration, weight concentration, mass concentration or the like.

The forward osmosis membrane as used is essentially made of a material that is the same as that used in a reverse osmosis membrane, and the size of the pore in the osmotic membrane is several times larger than a molecule of water (0.38 nanometers). The reason why a sodium ion (this is a major ion in seawater and is 0.12 to 0.14 nanometers per an ion) having a similar size to that of an oxygen atom becomes difficult to pass through an osmotic membrane is that water molecules coordinate to the circumference of the ion, thereby the ion acts as if it had an apparent size of several times to more than ten times. Furthermore, the presence of water molecules that attach to the surface of the membrane also acts to apparently decrease the pores.

The forward osmosis membrane as used may be selected from any of forward osmosis membranes that are known per se, depending on the properties and/or kinds of the object solution for separation and the solvent to be separated. For example, in the case when fresh water is to be separated from seawater, a forward osmosis membrane for seawater may be used.

Examples of the material for the forward osmosis membrane include a cellulose acetate membrane, a polyamide membrane and the like.

The forward osmosis membrane comprises two surfaces, i.e., a first surface and a second surface. The first surface contacts the object solution. The object liquid comprises a solvent and a solute, and the solvent that has contacted the first surface of the forward osmosis membrane and passed through the forward osmosis membrane transfers to the side of the second surface.

The object solution with which the first surface contacts may be the object solution from which the solvent is to be separated by said method. The object solution may be an inorganic solution and/or an organic solution. The inorganic solution may be, for example, an inorganic solution comprising, as a solute, at least one inorganic salt selected from the group consisting of sodium chloride, magnesium chloride, calcium chloride, sodium sulfate, magnesium sulfate and potassium sulfate and/or at least one organic salt selected from the group consisting of sodium acetate, magnesium acetate, sodium citrate and magnesium citrate in an aqueous liquid such as water, methanol or ethanol. The organic solution may be an organic solvent comprising a solute such as an organic substance such as a fiber and/or a resin in an organic solvent such as toluene or acetone.

The second surface of the forward osmosis membrane contacts the liquid for collection. The substance having solidity that is configured to exert a force for transferring the solvent in the object solution to the forward osmosis membrane is disposed on the surface of the second surface of the forward osmosis membrane and/or dispersed in the liquid for collection.

The liquid for collection may be a solvent of the same kind as that of the solvent included in the object solution, or may be other kind of solvent that can transfer to the second surface through the forward osmosis membrane. Preferably, the liquid for collection is a solvent of the same kind as that of the solvent included in the object solution.

The supply of the liquid for collection to the second surface may be added in advance so that a solvent that is the same as the solvent in the object solution contacts the second surface, or the solvent may be derived from the object solvent that has transferred from the object solution to the side of the second surface through the forward osmosis membrane. In order to initiate the separation of the solvent rapidly, it is preferable to supply the solvent prior to conducting the separation method to the extent that a part of the substance having solidity that contacts the second surface of the forward osmosis membrane is wet.

The substance having solidity may be a substance having an effect to exert a force for transferring the solvent in the object solution to the forward osmosis membrane.

Examples of the substance having solidity include a solid absorber such as a polymer absorber, an ion-exchanging resin, a salt having solidity, and a polymer absorber crosslinked by adding an aqueous solution of a salt of an alkali earth metal or the like. These may be used in combination.

The solid absorber as the substance having solidity may be, for example, a polymer absorber. The polymer absorber may be a highly absorbable polymer or a highly absorbable polymer whose surface is modified with a functional group. The highly absorbable polymer may be, for example, a starch-acrylic acid graft polymer, a saponified product of a starch-acrylonitrile copolymer, a crosslinked product of sodium carboxymethyl cellulose, an acrylic acid polymer and a polymer in the form of a salt thereof. Alternatively, these polymer absorbers may be used in combination.

The ion-exchanging resin as the substance having solidity may be, for example, any of cation-exchanging resins and anion-exchanging resins that are known per se.

Examples of the ion-exchanging group may include cation-exchanging groups such as a sulfonate group, a carboxylate group, an iminodiacetate group, a phosphate group and a phosphate ester group; and anion-exchanging groups such as a quaternary ammonium group, a tertiary amino group, a secondary amino group, a primary amino group, a polyethyleneimine group, a tertiary sulfonium group and a phosphonium group. The monomer as a basis for a polymer substrate on which these functional groups are mounted is generally a vinyl monomer. Examples of the vinyl monomer may include aromatic vinyl monomers such as styrene, α-methylstyrene, vinyltoluene, vinyl benzyl chloride, vinylbiphenyl and vinylnaphthalene; α-olefins such as ethylene, propylene, 1-butene and isobutene; diene-based monomers such as butadiene, isoprene and chloroprene; halogenated olefins such as vinyl chloride, vinyl bromide, vinylidene chloride and tetrafluoroethylene; nitrile-based monomers such as acrylonitrile and methacrylonitrile; vinyl esters such as vinyl acetate and vinyl propionate; and (meth)acrylic-based monomers such as methyl acrylate, ethyl acrylate, butyl acrylate, 2-ethylhexyl acrylate, methyl methacrylate, ethyl methacrylate, propyl methacrylate, butyl methacrylate, 2-ethylhexyl methacrylate, cyclohexyl methacrylate, benzyl methacrylate and glycidyl methacrylate. These monomers may be used by solely one kind or as a combination of two or more kinds. The vinyl monomers that are preferably used here are aromatic vinyl monomers such as styrene and vinyl benzyl chloride. Furthermore, two or more may be selected from these ion-exchanging resins and used in combination. Further preferable examples of the ion-exchanging resin are a polystyrene-based strongly acidic cation-exchanging resin comprising a sodium sulfonate salt, a polystyrene-based strongly basic ion-exchanging resin comprising tetramethylammonium chloride, or other basement on which the above-mentioned solid salt monomer has been graft-polymerized or a polymerized product of said monomer has been fixed by a chemical reaction; furthermore, two or more may be selected from these ion-exchanging resins and used in combination. The polymerization and fixing on the basement may be achieved by any method known per se.

By contacting the object solution with the first surface in a state that the substance having solidity is disposed on the second surface of the forward osmosis membrane as mentioned above, or in a state that the substance having solidity is dispersed in the liquid for collection that is contacting the second surface, the solvent included in the object solution can be transferred to the liquid for collection at the side of the second surface. The solvent that has transferred to the side of the second surface may be collected and used for a further purpose. Furthermore, the object solution is concentrated by separating the solvent. Therefore, the concentrated object solution or concentrated solute may be used for a further purpose.

Furthermore, in the case when the liquid for collection in which the substance having solidity is dispersed is used, a filter may be used so as to separate the solvent in the liquid for collection that has transferred to the side of the second surface and the substance having solidity. The filter as used herein may be a filter made of paper, a filter made of a resin, a filter made of a ceramic, a filter made of glass, or a combination of two or more of these filters. The filter may be constituted by a porous material, constituted by forming pores by perforating a membrane, or constituted by compositing a plurality of fibrous materials. The filter is used for separating the solvent that has been separated at the side of the second surface and the substance having solidity. Therefore, the filter mesh, i.e., pore has a size through which a component having solidity is not passed. By using such a filter, the object solvent can be separated and collected more easily.

By such a method, the solvent can be separated from the object solution by lesser energy. Furthermore, by separating the solvent, the solute can be concentrated in the object solution or separated from the object solution by lesser energy. Therefore, running costs can be decreased more than before.

2. Desalination of Seawater

The above-mentioned method may be used, for example, for desalinating seawater. In an embodiment used for desalinating seawater, it is only necessary to apply seawater as the object solution mentioned above.

In a conventional forward osmotic pressure seawater desalination process, a solution having a higher salt concentration than that of seawater is first prepared at the side opposite to seawater of an osmotic membrane so as to absorb pure water from seawater. In general, ammonium chloride is used as such a salt. Since ammonium chloride has a high solubility in water, decomposes by heating at a low temperature and releases ammonia and carbon dioxide as gases, the residual water becomes pure water.

The method for desalinating seawater in the exemplary embodiment may also be interpreted as a method comprising absorbing by swelling of a solid salt having a high mol concentration instead of conventional ammonium carbonate.

An example of the method comprising absorbing water in seawater by swelling of a solid salt for desalinating seawater of the exemplary embodiment is a method comprising preparing a forward osmosis membrane having a first surface and a second surface, and contacting the first surface of the forward osmosis membrane with the seawater and contacting the second surface with a liquid for collection, wherein a substance having solidity that is configured to exert a force for transferring the water in the seawater to the forward osmosis membrane is disposed on the surface of the second surface of the forward osmosis membrane and/or dispersed in the liquid for collection to transfer the water in the seawater from the first surface to the liquid for collection at the side of the second surface through the forward osmosis membrane, thereby fresh water is adsorbed by swelling from the object solution.

According to the method of the exemplary embodiment, the water separated from seawater can be collected as fresh water by applying a slight pressure to the forward osmotic pressure and passing the water through a filter, without subjecting the water to a subsequent heating process.

Although the amount of pure water obtained within a unit time depends on the pressure at the side from which seawater is loaded, if the whole system is constituted as a vertical type, pure water can be obtained by utilizing the pressure of water that falls by gravity. Namely, pure water can be obtained by only filtering seawater by using this system. This is a technique that is applied to a wide range of applications from simplified devices to large-scale plants.

By enabling desalination of seawater, water situations in the world can be improved. The problem of the present patent can decrease the significant energy for the desalination of seawater.

3. Separation Device

The above-mentioned method for separating a solvent and method for desalinating seawater can be conducted by, for example, the device as mentioned below.

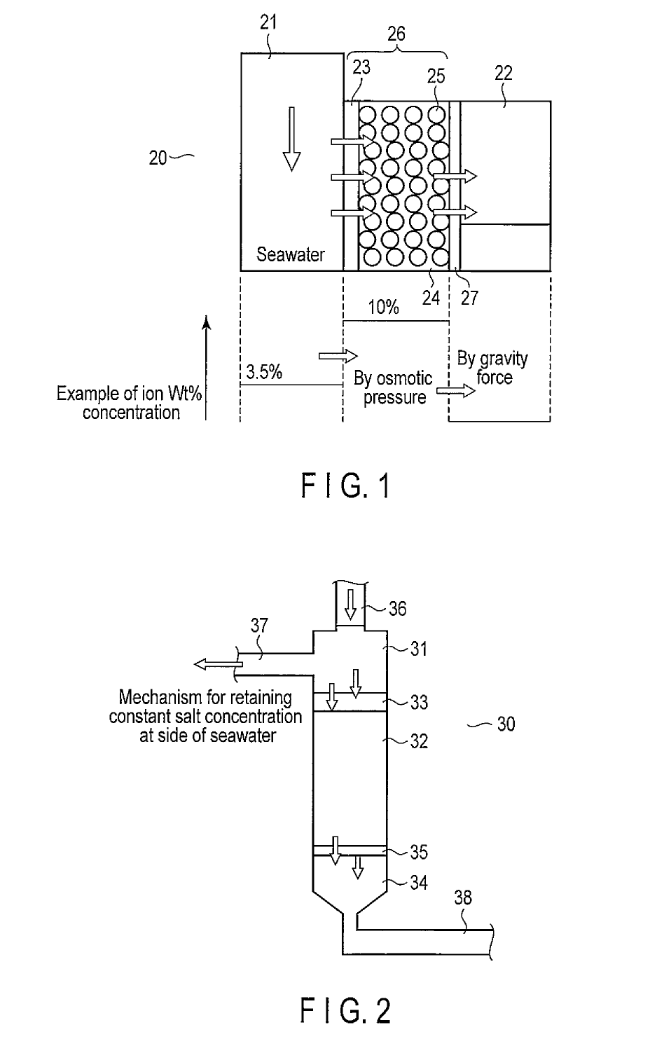

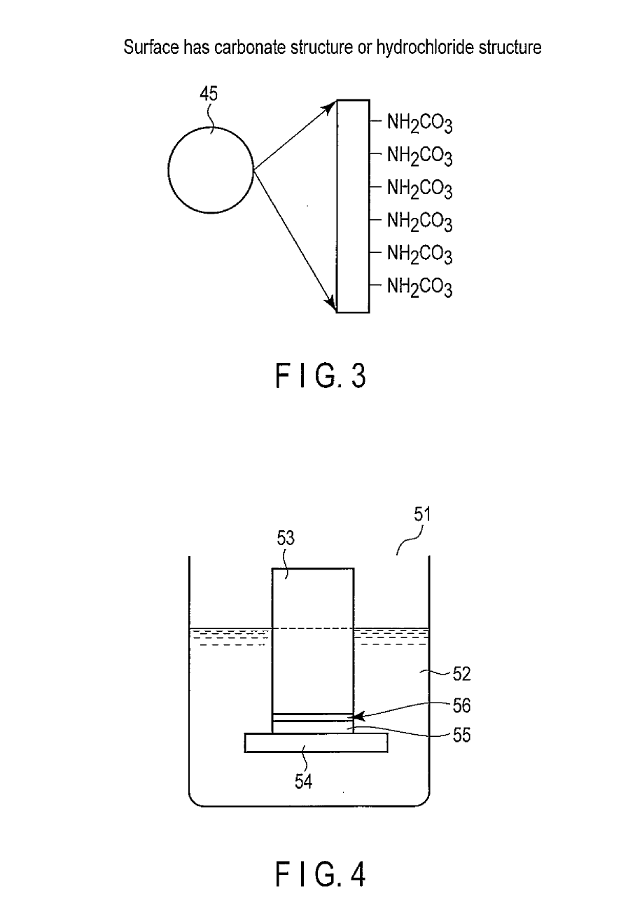

The separation device of the embodiment 1 will be explained referring to FIG. 1.

The separation device 20 comprises a first chamber 21 that is configured to house an object solution comprising a solvent and a solute, and a second chamber 22. The first chamber 21 and second chamber 22 communicate with each other at the insides thereof by a communicating unit 26. A forward osmosis membrane 23 comprising a first surface and a second surface is disposed on the communicating unit 26, by which the first chamber 21 and the second chamber 22 are spatially separated from each other. The first surface is positioned at the side of the first chamber 21, and the second surface is positioned at the side of the second chamber 22. An aggregate of a plurality of substances having solidity 25 is disposed on the communicating unit 26 so as to be positioned on the second surface of the forward osmosis membrane 23. The substance having solidity is a substance having an effect to exert a force for transferring the solvent in the object solution to the forward osmosis membrane 23. A filter 27 is disposed on the communicating unit 26 so that it is positioned on the surface of the aggregate of the substances having solidity 25 (the surface at the side of the second chamber 22).

An opening (not depicted) for loading a liquid for collection is formed on the upper side of the communicating unit 26. An opening (not depicted) for loading the object solution is formed on the upper side of the first chamber 21. Similarly, an opening (not depicted) for collecting the separated solvent is formed on the upper side of the second chamber 22. The separation device 1 except for said openings is airtight.

For the substance having solidity and forward osmosis membrane 23, the substances that are used for the above-mentioned separation method may be used.

The first chamber 21 houses the object solution.

The second chamber 22 houses the solvent that has been separated from the object solution.

The separation device 20 can be assembled, for example, by the following method. A chassis is formed from a desired plate, and the forward osmosis membrane 23 is fixed on a desired position on the inside thereof. By doing so, the inside of the chassis is partitioned by the forward osmosis membrane 23, thereby the first chamber 21 and the second chamber 22 are constituted. The portion of the second chamber 22 at the side of the second surface of the forward osmosis membrane 23 functions as the communicating unit 26. Furthermore, the aggregate of the substances having solidity 25 and filter 27 are fixed in this order on the communicating unit 26 at the side of the second surface of the forward osmosis membrane 23. By doing so, the separation device of the embodiment 1 is assembled.

A method for conducting solvent separation in the separation device 20 will be explained with exemplifying desalination of seawater. First, pure water is supplied to the communicating unit 26 of the separation device 20. The pure water flows into the second chamber 22 through the aggregate of the substances having solidity 25 and the filter 27. Next, seawater is loaded into the first chamber 21. By leaving this state, only the water component included in seawater transfers to the second chamber 22 through the forward osmosis membrane 23, the aggregate of the substances having solidity 25 and the filter 27. In the case when a separation operation is conducted continuously, it is only necessary to remove the fresh water that has been separated from the second chamber 22 by at least a desired amount, and/or to load additional seawater into the first chamber 21.

Alternatively, the degree of a first atmospheric pressure according to the seawater in the first chamber 21 and the degree of a second atmospheric pressure according to the liquid for collection comprising the separated solvent in the second chamber 22 may be adjusted in the above-mentioned separation operation. By adjusting the first atmospheric pressure to be higher than the second atmospheric pressure, the separation can be achieved rapidly.

For example, it is effective to adjust the heights of liquid levels so as to adjust the degree of the first atmospheric pressure and the degree of the second atmospheric pressure. The separation device 20 in FIG. 1 is constituted so that the liquid level of the first chamber 21 is positioned higher than the liquid level of the second chamber 22. Such a constitution is advantageous so as to achieve rapid and smooth separation. Furthermore, a higher pressure may be applied to the seawater included in the first chamber 21. However, in the separation device 20 of the exemplary embodiment 1, rapid and smooth separation can be achieved by only applying a small pressure that is half of or less than that in a conventional separation device utilizing a forward osmosis membrane.

By using such a separation device 20 of the exemplary embodiment 1, it becomes possible to separate the solvent from the object solution by lesser energy. Furthermore, by separating the solvent, it is also possible to concentrate the solute in the object liquid or to separate the solute from the object liquid by lesser energy. Therefore, running costs can be decreased more than before.

Although the amount of pure water obtained within a unit time depends on the pressure at the side from which seawater is loaded, if the whole system is constituted as a vertical type, pure water can be obtained by utilizing the pressure of water that falls by gravity. Namely, when a sufficient drop is present, pure water can be obtained by only filtering seawater by this system. This is a technique that is applied to a wide range of applications from simplified devices to large-scale plants.

By enabling desalination of seawater, water situations in the world can be improved. The problem of the present patent can decrease the significant energy for the desalination of seawater.

The above-mentioned exemplary embodiment 1 may also have the following constitution.

The inner shape and outer shape of the first and second chambers 21 and 22 may have any shapes, and the inner shape and outer shape may have the same or similar shapes or different shapes from each other. The inner shape and outer shape may be, for example, a chassis-like shape, a columnar shape, a square columnar shape, a curved surface shape such as a columnar shape or a spherical shape.

The communicated unit 26 may have any constitution as long as it is a constitution by which the insides of the first chamber 21 and the second chamber 22 communicate with each other. Therefore, it may be formed by forming an opening as a first opening in at least a part of the wall surface that defines the first chamber 21 and forming an opening as a second opening in at least a part of the wall surface that defines the second chamber 22, and joining the first opening and the second opening so that the openings face each other.

The joining in such a case may be conducted at the edgings and/or peripheries of the first and second openings. Alternatively, another wall surface may be joined to the edging and/or periphery of either one of the first and second openings. In either case, it is only necessary that the first chamber and the second chamber are in communication or circulation.

The joining may be conducted by any means known per se depending on the material and format of binding.

The first chamber and the second chamber may be joined by a tubular element. Furthermore, the boundary of the first chamber and the second chamber may be formed only by the forward osmosis membrane.

Using the separation device of the exemplary embodiment 1 as an unit, a plurality of units may be integrated and provided as a separation device.

Although the opening of the second chamber 22 is formed on the upper side in the exemplary embodiment 1, the separated solvent may be collected from the second chamber via an openable and closable opening that is formed in a part of the wall surface or the bottom surface that defines the second chamber 22. In accordance to this, the filter may be disposed on the openable and closable opening so that the substance having solidity is separated from the liquid that is ejected from the opening. Alternatively, the filter may be disposed on the exterior of the device of Example 1, or the filter may be provided removably to or fixed on the outside of the opening as necessary. Alternatively, a filter may be used for the ejected liquid as necessary, without providing a filter to the device of the exemplary embodiment 1.

Hereinafter the embodiments will be explained in detail.

### EXAMPLE 1

By using the exemplary embodiment 1 as shown in FIG. 1 and utilizing the experimental system as shown below, fresh water can be obtained from seawater.

As the constitution of the experimental system, a 3.5-wt % solution of sodium chloride is used on the seawater side, an osmotic membrane for desalination of seawater is disposed, and sodium acrylate as a polymer absorber is used on the opposite side to the seawater side and is swollen by fresh water in advance. The osmotic pressure at this time is in proportion to a mol number, and when the mol number at the side of salt water is 0.00059 mol/cc, the side of the polymer absorber has a mol number of 0.01255 mol/cc, which is a mol number of 21-fold, since sodium acrylate (MW: 94.04) has a density of 1.18 g/cc.

Since the osmotic pressures per a liter are calculated to be 14.5 atm and 296 atm, respectively, at 15° C., the osmotic pressure in the forward direction is 282 atm. There is a coarse filter at the side of the polymer absorber, and pure water that corresponds to the velocity of feeding of water from the seawater side passes through the filter and comes out. The present example is shown in FIG. 2.

### EXAMPLE 2

FIG. 2 is an example of the device of the exemplary embodiment 2 that is constituted by flowing seawater into the device without circulation so that the initial space for seawater separated by an osmotic membrane is constantly filled with seawater having a salt concentration of around 3.5 wt %.

The device 30 of the exemplary embodiment 2 comprises a columnar container comprising a drainage unit 38 on the lower end, which comprises therein a first chamber 31 comprising an opening 36 that is configured to introduce the object solution and an ejection unit for flowing without circulation 37, a forward osmosis membrane 33 that is disposed below the first chamber, a substance having solidity 32 that is disposed below the forward osmosis membrane, a filter 35 that is disposed below the substance having solidity, and a second chamber 34 into which the solvent that has transferred from the first chamber 31 flows through the forward osmosis membrane 33, substance having solidity 32 and filter 35. Since such an exemplary embodiment 2 has a constitution in which the respective layers are stacked, all flows are promoted smoothly by gravity.

In the case when filtration is conducted by gravity as in such a case, by feeding seawater to the uppermost portion at a velocity that is slightly faster than the velocity of filtration, increase in the seawater concentration in the initial space for seawater can be prevented, thereby fresh water can be taken continuously.

### EXAMPLE 3

FIG. 4 shows the constitution of an example of the substance having solidity, in the case when it is used as a solid absorber as the substance having solidity at the side on which the salt concentration of the osmotic membrane is increased, after modifying the surface of a particle as a salt structure. As the solid absorber, a polymeric polymer is used. It is possible to impart a carbonate structure or hydrochloride structure to the surface thereof. Such a constitution is achieved by neutralizing the surface with a functional powder of an amine and gaseous carbon dioxide or hydrochloric acid.

Such substance having solidity has a diameter that is a size larger than a filter mesh of several tens of microns, and thus the substance having solidity does not pass through a filter. Therefore, by using a filter, the substance having solidity and a solvent can be separated easily. Furthermore, in the case of such a structure, the structure can be replaced easily in the case when a problem such as deterioration of the solid absorber occurs.

### EXAMPLE 4

An ion-exchanging resin is exemplified as a material that is porous to the inside of a polymer and has a salt structure of a functional group. Since an ion-exchanging resin has been processed into particles each having a diameter of about 1 mm, it is easily handled, and by which pressure loss can be minimized by disposing a coarse filter. Examples of the ion-exchanging group to be introduced may include cation-exchanging groups such as a sulfonate group, a carboxylate group, an iminodiacetate group, a phosphate group and a phosphate ester group; and anion-exchanging groups such as a quaternary ammonium group, a tertiary amino group, a secondary amino group, a primary amino group, a polyethyleneimine group, a tertiary sulfonium group and a phosphonium group. The monomer as a basis for a polymer on which these functional groups are mounted is generally a vinyl monomer, and specific examples of the vinyl monomer may include aromatic vinyl monomers such as styrene, α-methylstyrene, vinyltoluene, vinyl benzyl chloride, vinylbiphenyl and vinylnaphthalene; α-olefins such as ethylene, propylene, 1-butene and isobutene; diene-based monomers such as butadiene, isoprene and chloroprene; halogenated olefins such as vinyl chloride, vinyl bromide, vinylidene chloride and tetrafluoroethylene; nitrile-based monomers such as acrylonitrile and methacrylonitrile; vinyl esters such as vinyl acetate and vinyl propionate; and (meth)acrylic-based monomers such as methyl acrylate, ethyl acrylate, butyl acrylate, 2-ethylhexyl acrylate, methyl methacrylate, ethyl methacrylate, propyl methacrylate, butyl methacrylate, 2-ethylhexyl methacrylate, cyclohexyl methacrylate, benzyl methacrylate and glycidyl methacrylate. These monomers can be used by solely one kind or as a combination of two or more kinds. The vinyl monomers that are preferably used in the embodiment are aromatic vinyl monomers such as styrene and vinyl benzyl chloride. Such ion-exchanging resin is preferably used in the exemplary embodiments 1 and 2.

### EXAMPLE 5

This example shows that the principle of the present patent is correct by fundamental experiments.

### Test 1: General Osmotic Pressure Experiment

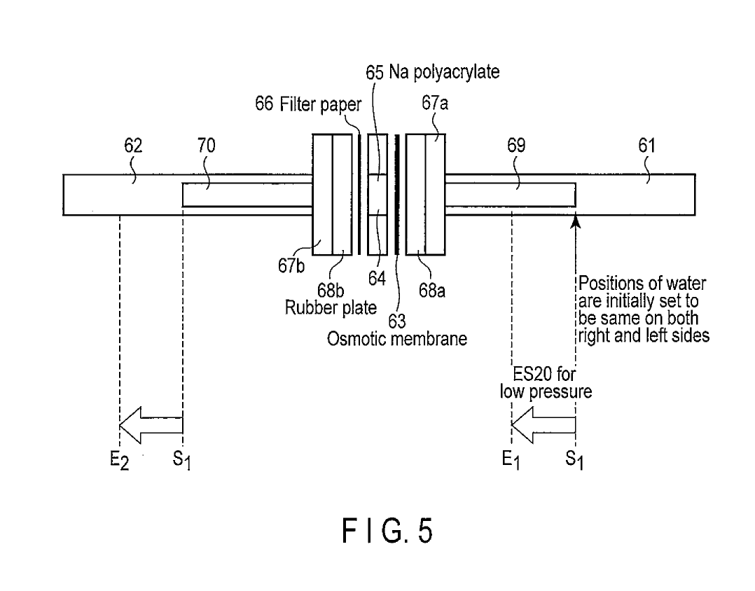

A test was conducted for osmotic pressures by using the device shown in FIG. 5. The device will be explained referring to FIG. 5. A piston was withdrawn from a 1 cc syringe for injection. Two syringes are fixed in the direction so that openings for withdrawing and inserting pistons face each other. An osmotic membrane and sodium polyacrylate housed in a support were disposed between the two syringes and fixed.

A 3.5-wt % aqueous NaCl was put into the left side and pure water was put into the right side, which were left at 15° C. The osmotic membrane as used was an osmotic membrane for seawater NTR-70SWC from Nitto Denko Corporation. The osmotic membrane was sandwiched by two rubber packings each having a thickness of 2 mm. A hole having a diameter of 5 mm was formed on the center of the rubber packings. The liquid inside transferred through this hole on the center of the rubber packings.

### Test 2:

Using a similar device to that of FIG. 5, an experiment was conducted by using an osmotic membrane for seawater from Nitto Denko Corporation (NTR 70SWC). The question is whether or not an osmotic pressure can be obtained at a salt of the polymer absorber or the inner structure of the ion-exchanging resin against the osmotic membrane. Therefore, a solid salt thereof, i.e., a solid absorber was put on one side of the osmotic membrane, and the both cells were filled with pure water. If water is absorbed by the side at which the solid salt is present by doing so, the proposed principle is considered to be correct. Sodium polyacrylate was used for the polymer absorber. Furthermore, in the case of the ion-exchanging resin, Amberlite (IRA910 CT C1, manufactured by Organo Corporation) was used. As the filter, Kimwipe was used. A rubber for holding the osmotic membrane, which was present on the medium of the cells, had a thickness of 2 mm, and a hole having a diameter of 5 mm was formed thereon by using an official punch.

When this diameter is used, if one side is occluded, water does not spill out even when the device is lifted vertically.

As a result of leaving this device, transfer of the liquid level to the side at which the solid salt is present was observed.

### Test 3:

Using the separation device shown in FIG. 4 as an experimental device, fresh water was separated from salt water having a concentration of seawater.

The separation device 51 comprises a first chamber 52, a second chamber 53, a forward osmosis membrane 54, a substance having solidity 55 and a filter 56.

The forward osmosis membrane was fixed so as to cover one opening of a hollow column of 30 mm diameter. A polymer absorber was disposed on the forward osmosis membrane in the hollow column, and filter paper was further disposed on the upper side of the polymer absorber. Sodium polyacrylate was used for the polymer absorber. Sodium polyacrylate has a molecular weight of 94.04. Salt water was adjusted by adding NaCl at 3.5% by weight to purified water. The salt water was introduced into the container, and thereafter the hollow column in which the forward osmosis membrane, polymer absorber and filter paper were disposed was disposed. By doing so, the molecular device 51 is constituted. The difference in the water level between the position of the polymer absorber in the column and the position of the water level of the salt water was 4 cm.

When this was left, 1.3 mL of a solvent, i.e., water could be separated from seawater in 18 hours. The salt concentration of this water was 2.3%. Although this membrane was for seawater, the salt component was incorporated.

In a similar device in which no filter paper was disposed, feed-water accompanying swelling of the polymer absorber by a height of 1 cm or more was generated in 48 hours.

Theoretically, an expected value of the difference in osmotic pressure in the system is as high as 268.31 atmospheric pressures if a polymer salt is used as the polymer absorber, as can be seen in Table 1 below. It is therefore expected that water moves toward the osmotic membrane beyond the forward osmosis membrane by a great force.

TABLE 1

| | | | | | | | | 15° C. | 25° C. |
|---|---|---|---|---|---|---|---|---|---|
| | | Density | Concentration | Amount of | | | mol ratio/ | Osmotic | Osmotic |
| | MW | g/cc | Wt % | solid g/cc | mol/cc | mol/liter | NaCl | pressure/liter | pressure/liter |
| NaCl | 59 | 1 | 3.5 | 0.035 | 0.00059322 | 0.59 | 1 | 28.02 | 28.99 |
| Sodium | 94.04 | 1.18 | | 1.18 | 0.01254785 | 12.55 | 21 | 296.33 | 306.62 |
| polyacrylate | | | | | | | | | |
| Expected value | | | | | | | | 268.31 | |
| of difference in | | | | | | | | | |
| osmotic pressure | | | | | | | | | |

### Test 4:

A further experiment was conducted by using a similar device to the separation device shown in FIG. 5, except that an osmotic membrane for a low pressure, ES20 from Nitto Denko Corporation, was used as the forward osmosis membrane. In said separation device, sodium polyacrylate was used as a substance having solidity. The concentration of the salt water was adjusted to 3.5% by weight. In FIG. 5, a first chamber 69 is in the syringe on the observer's right, and a second chamber 70 is in the syringe on the observer's left.

Salt water was put into the first chamber 69, and pure water was put into the second chamber.

The transfer velocity was 0.15 ml/h. The water surfaces of the salt water in the syringe and the pure water moved as follows in 16 hours; temperature: 15° C. to 9° C. Right side: 0.15 cc, left side: a little fewer than 0.1 cc; transfer velocity: 9.4×10⁻³ cc/h (5 mm diameter, hole). From this, the fact that the polymer absorber at the opposite side of the osmotic membrane aspirated and ejected water out of the filter paper could be confirmed.

### EXAMPLES

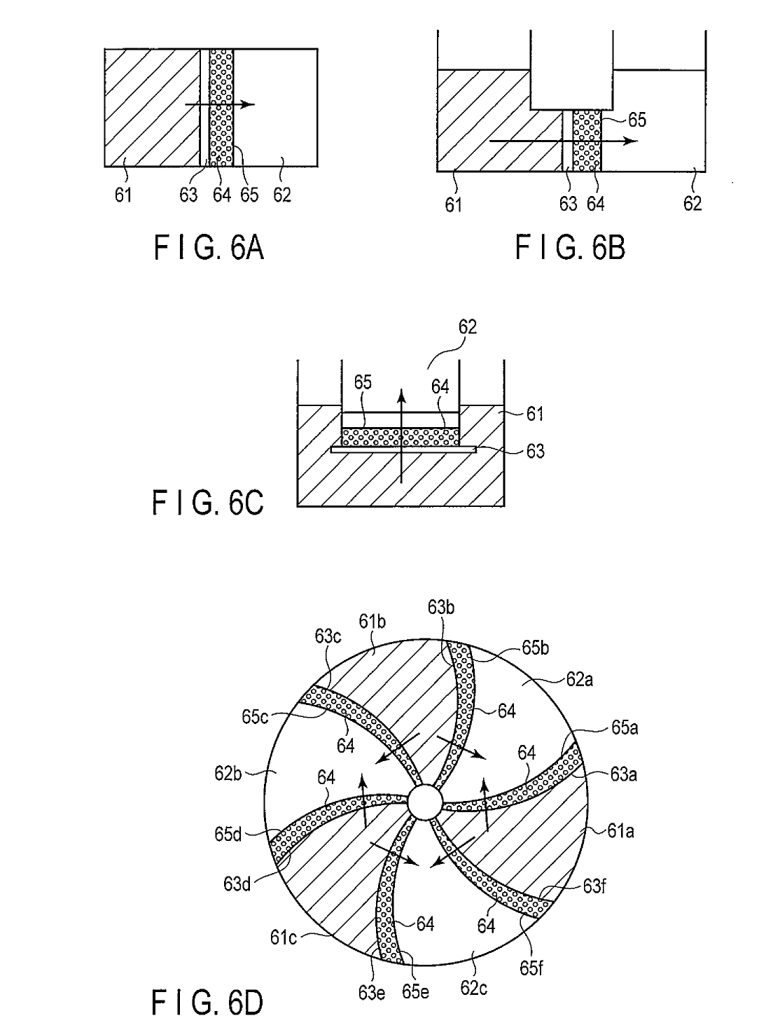

Furthermore, the examples of the constitution formats of the first chamber and second chamber are schematically shown in FIGS. 6A to 6D. In either separation device, a first chamber 61, a second chamber 62, a forward osmosis membrane 63 and a substance having solidity 65 are disposed. Furthermore, a filter 65 that is optionally disposed is shown in FIGS. 6A to 6D. For example, in the case when the substance having solidity 65 is fixed on the forward osmosis membrane 63, the filter 65 is not necessary.

Said separation device can comprise the respective constitutions by various dispositions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for separating a solvent from an object solution comprising the solvent and a solute, the method comprising:
preparing a forward osmosis membrane having a first surface and a second surface, and
contacting the first surface of the forward osmosis membrane with the object solution and contacting the second surface with a liquid for collection,
wherein a substance having solidity that is configured to exert a force for transferring the solvent in the object solution to the forward osmosis membrane is disposed on the second surface of the forward osmosis membrane and/or dispersed in the liquid for collection to transfer the solvent in the object solution from the first surface to the liquid for collection at the side of the second surface through the forward osmosis membrane, thereby the solvent is separated from the object solution.

2. The method according to claim 1, further comprising:
separating the solvent that has been transferred to the side of the second surface from the substance having solidity by passing through a filter.

3. The method according to claim 1,
wherein the substance having solidity is selected from the group consisting of a polymer absorber, an ion-exchanging resin and a salt having solidity, and a polymer absorber, an ion-exchanging resin and a salt having solidity each having a form being bound to the second surface of the forward osmosis membrane, and combinations thereof.

4. The method according to claim 2,
wherein the substance having solidity is selected from the group consisting of a polymer absorber, an ion-exchanging resin and a salt having solidity, and a polymer absorber, an ion-exchanging resin and a salt having solidity each having a form being bound to the second surface of the forward osmosis membrane, and combinations thereof.

5. The method according to claim 1,
wherein the substance having solidity is a solid absorber.

6. The method according to claim 2,
wherein the substance having solidity is a solid absorber.

7. The method according to claim 1,
wherein the substance having solidity is a highly absorbable polymer or a highly absorbable polymer whose surface is modified with a functional group.

8. The method according to claim 2,
wherein the substance having solidity is a highly absorbable polymer or a highly absorbable polymer whose surface is modified with a functional group.

9. The method according to claim 1,
wherein the substance having solidity is selected from the group consisting of a starch-acrylic acid graft polymer, a saponified product of a starch-acrylonitrile copolymer, a crosslinked product of sodium carboxymethyl cellulose, an acrylic acid polymer and a polymer in the form of a salt thereof, a polystyrene-based strongly acidic cation-exchanging resin comprising sodium sulfonate, a polystyrene-based strongly basic ion-exchanging resin comprising tetramethylammonium chloride, or any of said resins that is in the form being fixed on a basement by graft polymerization or polymerization with a solid salt monomer, and combinations thereof.

10. The method according to claim 2,
wherein the substance having solidity is selected from the group consisting of a starch-acrylic acid graft polymer, a saponified product of a starch-acrylonitrile copolymer, a crosslinked product of sodium carboxymethyl cellulose, an acrylic acid polymer and a polymer in the form of a salt thereof, a polystyrene-based strongly acidic cation-exchanging resin comprising sodium sulfonate, a polystyrene-based strongly basic ion-exchanging resin comprising tetramethylammonium chloride, or any of said resins that is in the form being fixed on a basement by graft polymerization or polymerization with a solid salt monomer, and combinations thereof.

11. The method according to claim 1, wherein the object liquid is seawater.

12. The method according to claim 2, wherein the object liquid is seawater.

13. A device for separating a solvent from an object solution comprising the solvent and a solute, the device comprising:
a first chamber that is configured to house the object solution;
a second chamber that is configured to house a liquid for collection, which communicates with the first chamber;
a forward osmosis membrane comprising a first surface that is positioned at the side of the first chamber and a second surface that is positioned at the side of the second chamber, which is disposed on a communicated part so as to separate the first chamber and the second chamber; and
a substance having solidity that is configured to exert a force for transferring the solvent in the object solution in the first chamber to the forward osmosis membrane, which is disposed in the second chamber so that at least a part of the substance having solidity contacts the surface of the second surface of the forward osmosis membrane.

14. The device according to claim 13,
wherein the device further comprises a filter in the second chamber so that the filter separates the solvent that has been transferred to the side of the second surface from the substance having solidity by passing through a filter, and the second chamber further contains an opening that is disposed so as to collect the solvent from the second chamber.

15. The device according to claim 14,
wherein the substance having solidity is disposed between the filter and the forward osmosis membrane in the second chamber.

16. The device according to claim 15,
wherein the substance having solidity is selected from the group consisting of a polymer absorber, an ion-exchanging resin and a salt having solidity, and a polymer absorber, an ion-exchanging resin and a salt having solidity each having a form being bound to the second surface of the forward osmosis membrane, and combinations thereof.

17. A device for separating a solvent from an object solution comprising the solvent and a solute,
the device comprising:
a first chamber that is configured to house the object solution;
a second chamber that is configured to house a liquid for collection, which communicates with the first chamber;
a forward osmosis membrane comprising a first surface that is positioned at the side of the first chamber and a second surface that is positioned at the side of the second chamber, which is disposed on a communicated part so as to separate the first chamber and the second chamber;
a substance having solidity that is configured to exert a force for transferring the solvent in the object solution in the first chamber to the forward osmosis membrane, which is disposed on the second surface of the forward osmosis membrane; and
a filter that is configured to separate the solvent from the substance having solidity, which is disposed adjacent to the substance having solidity.
